(19) United States
(12) Patent Application Publication
(10) Pub. No.: US 2014/0277887 A1
(43) Pub. Date: Sep. 18, 2014

(54) METHOD AND SYSTEM FOR DETECTING BATTERY TYPE AND CAPACITY AND AUTOMATICALLY ADJUSTING RELATED VEHICLE PARAMETERS

(71) Applicant: WM GreenTech Automotive Corp., McLean, VA (US)

(72) Inventors: Ethan Slattery, Moutain View, CA (US); Zachary Omohundro, Hermosa Beach, CA (US); Youssef Daou, Southaven, MS (US)

(21) Appl. No.: 14/212,550

(22) Filed: Mar. 14, 2014

Related U.S. Application Data
(60) Provisional application No. 61/798,299, filed on Mar. 15, 2013.

(51) Int. Cl. B60L 11/18

(52) U.S. Cl. CPC B60L 11/1851
USPC 701/22

(57) ABSTRACT

An electric vehicle and a method for adjusting vehicle parameters based on a type of battery modules inserted into a vehicle. A processor is configured to: receive at least one input parameter from the battery modules housed in the vehicle; determine at least a type (e.g., lithium or lead acid) and capacity of the battery modules in the vehicle; and adjust output parameters to a battery management system and one or more vehicle subsystems based on the determined type and capacity of battery modules. Accordingly, battery packs can be swapped without updating electrical software in the vehicle. A customer can alternate from one type of battery pack module to another more easily and can obtain cost savings. The method can be implemented using CAN bus protocol.

### CROSS REFERENCE TO RELATED APPLICATION

This application is related to and claims priority to U.S. Provisional Patent Application Ser. No. 61/798,299, filed Mar. 15, 2013, which is hereby incorporated by reference herein in its entirety.

### BACKGROUND

1. Field

The present disclosure is generally related to a battery management system. More specifically, it relates to a method for adjusting vehicle parameters based on the type of battery modules inserted into a vehicle.

2. Description of Related Art

Electric vehicles use batteries to provide power to a motor, brakes, and the like. Such batteries are installed in the vehicle for connection to contacts or fittings to deliver power to an associated device or system.

In general, it is known to insert and remove batteries relative to vehicles as modular packs. Batteries are typically configured for installation into a predetermined location in the vehicle. Historically, battery packs, such as lead acid and lithium batteries, require very different vehicle level controls and firmware.

### SUMMARY

One aspect of this disclosure provides a method for adjusting vehicle parameters based on a type of battery modules inserted into a vehicle. The vehicle is configured to interchangeably accommodate at least two different types of batteries comprising a plurality of modules provided therein. Each module includes a plurality of batteries of a first type arranged into a first battery module that is interchangeable with a plurality of batteries of at least a second type arranged into a second battery module, the at least second type of batteries being different from the first type of batteries. Both of the first type and the at least second type of batteries are each separately configured to supply power to the vehicle. The vehicle includes a processor configured to communicate with a battery management system configured to monitor the modules and with one or more vehicle subsystems via a vehicle communication protocol. Each of the processor, the battery management system and the one or more vehicle subsystems have an input and output. The processor is configured to perform the method including: receiving at least one input parameter from the battery modules arranged in the vehicle of the vehicle via the vehicle communication protocol; determining at least a type and capacity of battery modules arranged in the vehicle based on the received one or more input parameters; adjusting output parameters to the battery management system and the one or more vehicle subsystems based on the at least determined type and capacity of battery modules, and outputting the adjusted output parameters to the battery management system and the one or more vehicle subsystems via the vehicle communication protocol.

Another aspect of this disclosure includes an electric vehicle including: a body configured to interchangeably accommodate at least two different types of batteries having a plurality of modules, each module including a plurality of batteries of a first type arranged into a first battery module that is interchangeable with a plurality of batteries of at least a second type arranged into a second battery module, the at least second type of batteries being different from the first type of batteries, and both the first type and the at least second type of batteries each separately configured to supply power to the vehicle; a battery management system for monitoring the plurality of modules; a plurality of vehicle subsystems; and a processor configured to communicate with the battery management system and with one or more of the plurality of vehicle subsystems via a vehicle communication protocol. Each of the processor, the battery management system and the one or more vehicle subsystems have an input and output. The processor is configured to: receive at least one input parameter from the battery modules arranged in the body of the vehicle via the vehicle communication protocol; determine at least a type and capacity of battery modules arranged in the vehicle based on the received one or more input parameters; adjust output parameters to the battery management system and the one or more vehicle subsystems based on the at least determined type and capacity of battery modules, and output the adjusted output parameters to the battery management system and the one or more vehicle subsystems via the vehicle communication protocol.

Yet another aspect of this disclosure includes a non-transitory computer readable medium having stored computer executable instructions. The computer executable instructions, when executed by a computer, directs a computer to perform a method for adjusting vehicle parameters based on a type of battery modules inserted into a vehicle. The method includes: receiving at least one input parameter from the battery modules arranged in the vehicle of the vehicle via a vehicle communication protocol; determining at least a type and capacity of battery modules arranged in the vehicle based on the received one or more input parameters; adjusting output parameters to a battery management system configured to monitor the modules and one or more vehicle subsystems based on the at least determined type and capacity of battery modules, and outputting the adjusted output parameters to the battery management system and the one or more vehicle subsystems via the vehicle communication protocol.

Other features and advantages of the present disclosure will become apparent from the following detailed description, the accompanying drawings, and the appended claims.

### BRIEF DESCRIPTION OF THE DRAWINGS

FIG. 1 is an oblique front view of an embodiment of a vehicle body.

FIG. 2 illustrates a block diagram illustrating parts of a system of a vehicle for determining and adjusting parameters based on batteries in the vehicle.

FIG. 3 illustrates a method for adjusting vehicle parameters based on a type of battery modules inserted into a vehicle in accordance with an embodiment.

FIG. 4 illustrates a schematic diagram of a battery management system in accordance with an embodiment.

FIG. 5 illustrates a schematic diagram of a contactor control module in the battery management system of FIG. 4 in accordance with an embodiment.

FIG. 6 illustrates a schematic diagram of a ready indicator module in the contactor control module of FIG. 5 in accordance with an embodiment.

FIG. 7 illustrates a schematic diagram of a soft start control module in the battery management system of FIG. 4 in accordance with an embodiment.

FIG. 8 illustrates a schematic diagram of a torque limitation module in the battery management system of FIG. 4 in accordance with an embodiment.

FIG. 9 illustrates a schematic diagram of a battery fault module in the battery management system of FIG. 4 in accordance with an embodiment.

FIG. 10 illustrates a schematic diagram of a voltage level module in the battery management system of FIG. 4 in accordance with an embodiment.

FIG. 11 illustrates a schematic diagram of a current measurement module in the battery management system of FIG. 4 in accordance with an embodiment.

FIG. 12 illustrates a schematic diagram of a distribution module in the battery management system of FIG. 4 in accordance with an embodiment.

### DETAILED DESCRIPTION OF THE PREFERRED EMBODIMENT(S)

Historically, lead acid batteries and lithium batteries require very different vehicle level controls and firmware/software when installed in vehicles. This disclosure makes it easier for a customer to alternate battery packs without any major integration or reworking of the systems. Specifically, the method, when implemented, is capable of automatically differentiating between various types and capacity battery packs and adjusting vehicle parameters according to the same.

In the embodiments disclosed herein, two different types of batteries are described for mounting in the vehicle, namely, lead-acid and lithium batteries. However, it should be understood that such types of batteries are not meant to be limiting. That is, it is also envisioned that other types of batteries may be provided in the vehicle. At least a first type and a second type of battery modules are distinguishable by the herein disclosed method, system, and program. In an embodiment, the type of batteries provided are configured for mounting in and use with an electric vehicle.

For example, FIG. 1 illustrates an example of an electric vehicle 10 comprising a vehicle body 12 with a housing 14 therein (also referred to throughout as battery housing 14; shown in phantom lines in FIG. 1) for receiving battery packs or modules. In the exemplary illustrated embodiment, housing 14 is provided in a front end of the vehicle body, e.g., on the vehicle chassis. However, it should be understood that the battery housing 14 can be placed in one or more different locations in the vehicle, including a rear end of the vehicle. Moreover, a housing need not be provided.

In an embodiment, vehicle 10 is configured to interchangeably accommodate batteries in the form of battery modules or packs. A plurality of a first type of modules or a second type of modules can be provided within the vehicle. Both of the first type and the at least second type of batteries are each separately configured to supply power to the vehicle. For example, for the first type, each module comprises a plurality of batteries of a first type arranged in a first configuration into a first battery module. Each of the first battery modules may be interchangeable with a plurality of batteries of at least a second type arranged in a second configuration into a second battery module. The at least second type of batteries is different from the first type of batteries.

In an embodiment, the types of batteries that vehicle 10 is configured to accommodate are (at least) lithium batteries and lead acid batteries. Lithium battery packs are generally more expensive (e.g., four times more expensive) and lighter than lead acid batteries. However, lead acid batteries tend to have a longer life span as compared to lithium batteries.

In one embodiment, housing 14 is configured to receive and house at least two different types of batteries, at separate times. That is, either a first type or at least a second type of batteries are provided in housing 14 and used with the electric vehicle 10. Typically, in known systems, a different package design and system components (assembled by different types of assembly equipment) are used for each type of battery that is configured for mounting in a vehicle. Thus, different housings and equipment are used. However, in accordance with a non-limiting embodiment, housing 14 allows for different types and capacities of batteries to be provided in the same package in a vehicle, and without change of major components. Housing 14 can be used in any electric vehicle where cost may be a concern and where there is a desire or need to offer a number of different types of batteries for use therein. For example, in an embodiment, a housing such as disclosed in U.S. Pat. No. 5,378,555, issued on Jan. 3, 1995 or in U.S. Ser. Application Ser. No. 61/790,067, filed Mar. 15, 2013 (which is assigned to the same assignee), both of which are incorporated by reference herein in their entirety, may be implemented in the vehicle and with this disclosure.

The batteries or modules in vehicle 10 are designed to be associated with any number of devices in the vehicle, and, as further described below, configured to communicate via a vehicle communication protocol. Both the first type and the at least second type of batteries are each separately configured to supply power to the electric vehicle and its systems. The application and use of power from batteries is not meant to be limiting.

As understood by one of ordinary skill in the art, electrical connection of each of the modules can be established upon installation. For example, positive and negative terminal contacts for connection with modules is also provided in the vehicle. In an embodiment, an electronic module system (EMS) or electronic control unit (ECU) associated with the type of battery modules positioned in vehicle 10 can be provided for connection thereto. The boxes or devices associated with the EMS or EMC can be sized for each of the different configurations of batteries. The EMS or EMC is typically manufacturer defined.

Alternatively and/or also included in vehicle 10 and associated with the modules is a battery management system (BMS) 18. FIG. 2 illustrates a block diagram illustrating BMS 18 and other parts of a vehicle system 15 for determining and adjusting parameters based on batteries in the vehicle. Vehicle system 15 comprises, among other devices, memory 16, optional storage 17, BMS 18, processor 20, and vehicle subsystem(s) 22. Generally, these elements or modules (as will be described) are provided to perform functions that assist in determining a type and capacity of batteries arranged in a vehicle, and if or as needed, adjusting and outputting parameters to the BMS 18 and/or vehicle subsystem(s) 22 to accommodate for the type and capacity of the batteries. However, it should be noted that vehicle system 15 may comprise additional elements and/or modules not described herein or alternative elements for performing similar functions, and should not limited to those elements as illustrated in FIG. 2. Additionally, vehicle system 15 may also include one or more controllers or routers (not shown) to select and route data between the BMS 18, processor 20, subsystem(s) 22, and other elements, for example.

Each of the processor, the battery management system and the one or more vehicle subsystems have an input and output and can communicate with each other as well as memory 16 and/or storage 17.

Memory 16 and/or storage 17 may be used to store settings, tables (e.g., look up tables), constants, limits, parameters, etc. They may be used to temporarily and/or permanently storage data related to the vehicle system 15. Memory 16 and/or storage 17 may also be coupled to a bus as storage for machine readable and executable instructions to be executed by the processor 20 or computer. The memory 16 and/or storage 17 may be implemented using static or dynamic RAM (random access memory), a floppy disk and disk drive, a writable optical disk and disk drive, a hard disk and disk drive, flash memory, or the like, and may be distributed among separate memory components. The memory 16 and/or storage 17 can also include read only memory (ROM) or other removable or static storage drive(s) or memory devices. Such devices are not meant to be limiting.

BMS 18 is configured to monitor the plurality of battery modules. For example, as detailed in the explanation below, BMS 18 can be used to monitor, among other features, a temperature and a voltage of the batteries arranged in vehicle 10. BMS 18 can communicate with the electric vehicle 10 regarding an amount of power supplied and/or control commands based on monitoring settings. The BMS 18 can include any number of devices associated therewith. The number of devices in the BMS 18 and parameters input and output can be adjusted based on the number of battery modules arranged in the vehicle 10 as well as by the number of vehicle subsystem(s) 22 associated therewith. FIG. 4, described below, illustrates a schematic diagram of battery management system 18 in accordance with an embodiment. Also included in system 15 is a plurality of vehicle subsystems 22. Such subsystems may include but are not limited to: an engine management control unit, a safety system, an accident avoidance system, a braking system, a steering control unit, a regenerative power system, a charging current system. Further regenerative power, charging current, limp home, a state of health (SOH), a state of charge (SOC), cell safety protections (Hardware, and Software), control of contactors (e.g., via Software or Hardware), power control (e.g., as function of SOC and/or as function of temperature, capacity, SOH, age) can be considered and monitored by the BMS 18.

Processor 20 as shown in FIG. 2 is designed to represent one or more processors or processing elements or modules for processing and/or manipulating parameters using a plurality of operations and/or processes. In some instances, the processor can be a computer. The description of the processor below is an example of a device capable of communicating with and implementing processes to be performed and should not be limiting. For example, additional processors may be provided in vehicle system 15. Additionally and/or alternatively, additional operations may be performed to input and/or output parameters other than or in addition to those described herein.

A “processor” as used herein refers to one or more elements capable of executing machine executable/readable program instructions. Processor 20 may be a combination of processing elements which comprise software and hardware elements that perform a number of operations on received input data from BMS 18, memory 16, and/or subsystems 22 using a set of parameters. The parameters may be predefined and are used to alter, adjust, change, or maintain input to systems within vehicle 10, as desired.

Processor 20 configured to communicate with BMS 18 and with one or more of the plurality of vehicle subsystems 22 via a vehicle communication protocol. Processor 20 is configured to implement a method 24 for adjusting vehicle parameters based on a type of battery modules inserted into a vehicle. Exemplary steps of method 24 are shown in FIG. 3. Method 24 is implemented by a processor (such as processor 20), controller (or microcontroller) or similar device, as known in the art. Processor 20 communicates with memory 16 and BMS 18 (and optionally storage 17 and/or vehicle subsystems 22). Method 24 includes the processor being configured to: receive at least one input parameter from the battery modules arranged in the vehicle via the vehicle communication protocol, as shown at 26; determine at least a type and capacity of battery modules arranged in the vehicle based on the received one or more input parameters, as shown at 28; adjust output parameters to the battery management system and the one or more vehicle subsystems based on the at least determined type and capacity of battery modules, as shown at 32, and output the adjusted output parameters to the battery management system and the one or more vehicle subsystems via the vehicle communication protocol, as shown at 34.

In an embodiment, processor may optionally be configured to determine a configuration of the plurality of modules provided in the vehicle, shown at 30 in method 24 of FIG. 3. Accordingly, in one embodiment, the adjusting of the output parameters to the battery management system and the one or more vehicle subsystems at 32 may (further) include adjustments based on the determined configuration. Output parameters that are adjusted for the one or more vehicle subsystems can include, but are not limited to: parameters from the BMS, e.g., state of charge (SOC), state of health (SOH), current, voltage, temperature, and capacity (as ratio of design capacity).

In an embodiment, the processor is configured to determine if the battery modules are either a first type or a second type. The types of batteries determined and/or provided in the vehicle are not limited. However, in accordance one embodiment, the types of batteries configured for arrangement and mounting in the vehicle are lithium batteries and lead acid batteries. Accordingly, the processor may be configured to determine if lithium or lead acid batteries are arranged in the vehicle.

In an embodiment, the configuration and types are determined via coding a power control module (PCM), or coding the BMS 18 by stating the type of configuration in a memory space of the BMS 18. In another embodiment, the processor is configured to determine the type and/or configuration by determining an end of charging voltage of the batteries (or battery modules), since the end of charge voltage output different between lead acid and lithium batteries.

In an embodiment, up to five types of configurations can be determined. For example, the five types of configurations to be determined may include: two lead acid or SLA batteries as a first and second configuration, and up to three other or alternative configurations for lithium or LFP batteries. The configuration of LFP is xx series cells and 1, 2, or 3 parallel or xxSnP, for example. Such configurations are distinguishable by software coding, or by measuring the charge or discharge current (or voltage). The different configurations can affect the output from the batteries, including the capacity (which affects the value for the SOC), the output current (in charging or discharging), and the total power (that can affect the range) of the battery modules.

In another embodiment, the processor is configured to adjust output parameters (e.g., such as those mentioned above, associated with the BMS) by adjusting the state of charge of the battery modules. As understood by one of ordinary skill in the art, the SOC determination of lead acid batteries is based on voltage, while the SOC determination of Lithium batteries is based on coulomb counting. Accordingly, the voltage supply or counting can be adjusted.

As an example, the chemistry of lead acid batteries may dictate the output current/the discharge current as around 0.7 (any higher value may affect the capacity of the battery pack and make the pack discharge very fast and stop working once it reaches the minimum voltage of the cells). Lithium batteries, on the other hand, have a much higher discharge current which can be approximately three times the rated discharge current. Thus, the maximum power that will be extracted from the lithium battery pack is higher at higher discharge current, than the lead acid batteries. Accordingly, the cut-off voltage of the lithium batteries is different than the lead acid. The SOC determination is different between both chemistries and the algorithm to determine it is different (such algorithms are known by those of ordinary skill in the art and thus not explained in detail herein). The adjustment of the SOC, then, is dependent upon the type of batteries being implemented, and thus can be considered by the processor.

The vehicle communication protocol used by processor 20 for communication with the devices in vehicle 10 is not limited. In an embodiment, processor 20 communicates via a Controller Area Network (CAN) interface and the vehicle communication protocol is a CAN bus protocol. As understood by one of ordinary skill in the art, a CAN network in a vehicle implements a serial bus system that allows processors (or microcontrollers) and CAN devices or nodes to communicate with each other via each electronic control unit (ECU) associated with a subsystem. CAN networks are used to control the devices (via ECUs) or to provide an interface to the information that is available in other CAN-based in-vehicle networks (IVN) or subsystems 22, such as a power-train and/or an engine management control unit, safety systems (e.g., airbags and seatbelts), accident avoidance systems, braking systems (e.g., ABS), a steering control unit, etc. Different CAN-based IVNs are connected via gateways. Gateway functionality can be implemented in the dashboard of the vehicle. The dashboard itself may be equipped with a local CAN network connecting different displays and instruments. CAN-based systems are internationally standardized by the International Standards Organization (ISO) (e.g., ISO 11898, ISO 11519, and ISO 16845). As understood by one of ordinary skill in the art, the devices/subsystems described herein that are connected by a CAN network include but are not limited to sensors, actuators, and control devices, typically connected through a host processor and a CAN controller, and distributed throughout the vehicle 10.

Other protocols, however, can also be implemented. In accordance with an embodiment, the vehicle communication protocol can be: ISO 11898-1, -2 or -3, CAN 2.0, or SAE J1939.

When implementing a vehicle communication protocol such as via a CAN network in an electric vehicle, such as vehicle 10, the state of the vehicle and its subsystems are monitored and analyzed so that the subsystem(s) 22 can receive appropriate input, engine can be started/restarted during hybrid drives. This is done by processor 20, which can receive its data from various sensors and devices distributed throughout the vehicle, and from the CAN in-vehicle networks in the vehicle. For example, based on the input and readings of processor 20 and BMS 18, control strategies and input for functions such as stopping and starting as well as regenerative braking can be altered.

In an embodiment, CAN bus messages are used to communicate at least the type and capacity of battery modules arranged in the vehicle. For example, the processor or ECU may be designed to look for certain CAN bus message(s). Based on the message(s) it receives, the processor is configured to adjust vehicle level parameters and other data communicated to gauge clusters of the vehicle subsystems.

FIG. 4 shows a schematic diagram 100 of an example embodiment of a battery management system (i.e., BMS 18) implemented in vehicle 10. BMS 18 comprises, for example, an inter process communication distribution module 102 having input and output and a plurality 104 of other modules associated with parameters determined and/or recognized by battery management system (BMS) and associated with the batteries when a plurality of modules are arranged in the vehicle 10. The processor or each ECU associated with the system (including inter process communication distribution module) is configured for updating, as needed. As previously noted, in accordance with an embodiment, such communicated parameters include at least a type and a capacitance of the batteries mounted therein, as well as voltage and current levels. Moreover, the BMS can read and provide input to one or more vehicle subsystem(s) 22 based on the readings and determinations made by module 102 and 104.

In the illustrated embodiment of FIG. 4, inter process communication distribution module 102 is configured to receive input, referred to herethroughout at BMS_Input 106, and to produce output to the associate modules 104 and vehicle subsystem(s), referred to as BMS_Output 108. BMS_Input 106 may include digital to analog CAN based gathering and converting and designed to receive continuously fed bus signals. BMS_Output 108 comprises data related to distributing output functions in CAN, analog, etc. to display, communicate, actuate, etc. subsystems 22.

Inter process communication distribution module can communicates via vehicle communication protocol using algorithms and control commands with modules 104 associated with readings and performance of the arranged battery modules in vehicle 10. Such modules 104 may include contactor control module 110, torque limitation module 112, battery fault module 114, voltage level module 116, and current measurement module 118, for example. Inter process communication distribution module 102 receives input from each of these modules 110-118 and, considering also BMS_Input 106, outputs data as input to each of these modules. More specifically, based on the BMS_Input 106, inter process communication distribution module 102 can alter, update, or maintain the settings of the associated modules 104 to update systems in the vehicle 10. FIG. 12 illustrates a schematic diagram of the features and factors considered by Inter process communication distribution module 102 in the battery management system of FIG. 4, which are further understood by the features shown and described with reference to FIGS. 5-11.

For example, Contactor control module 110 is configured to communicate and output data cont_output regarding safety systems of the vehicle to inter process communication distribution module 102. The input (from Contactor Control module 110) to Inter process communication distribution module 102 is referred to as soft start control input, SSC_In. Such input remains primarily active on startup and determines if the vehicle is ready for use. For example, based on the received input, Contactor Control module 100 can alert (e.g., via a ready indictor light 130 on a dashboard) a user that the vehicle is ready (e.g., for adjustment of voltage (e.g., start, ramp up), after crank is activated). Inter process communication distribution module 102 may output data SSC for input Cont_Input into Contactor Control module 110.

FIGS. 5-7 show a more detailed view of the modules and parameters analyzed and affected by Contactor Control module 110 in greater detail. FIG. 5 shows that when Cont_Input is received from Inter process communication distribution module 102, a Ready Indicator determination 120 and Soft Start Control determination 122 each receive a plurality of input parameters. Such determinations may be made by one or separate modules. With regards to Ready Indicator, the module receives parameters related to gear selection (Forward, Neutral, Drive), keyswitch determination, current (+ or −), voltage, and a main contactor, MainCont. The input MainCont is received from Soft Start Control module. Ready indicator determines the state of the system, e.g., if the system is ready to drive and outputs a ready signal. An alert is sent to ready indicator lamp 130, as shown in more detail in FIG. 6. With regards to Soft Start Control, the module receives parameters related to if the system is read (from Ready Indicator determination 120), keyswitch determination, battery fault, voltage fault, and voltage. Based on the determination, a primary and secondary flow is output to contactors. A determination regarding the Main Contactor current flow MainCont is saved in memory 128 (or memory device 16) before its use by Ready indicator. Secondary contactor determination SSCont allows current to flow from battery to systems in a limited capacity, as needed. The combined ready and contactor determinations are sent as output Cont_Output 126 to at least module 102.

As noted above, FIG. 6 shows parameters and determinations made for calculating the state of system for driving with regards to the Ready Indicator determination 120 of FIG. 5. Its output 143 is sent for use in Soft Start Control determination 122 and used to light a ready lamp indicator 130 (e.g., on dashboard). More specifically, FIG. 6 shows how the input data, gear selection, key switch, pack current and voltages, and contactor current determinations are compared to constants (e.g., obtained from memory 16 or storage 17) to determine if the current, voltage, etc. of batteries are within a range before operation and is ready. For example, the positive current data is compared to a constant to determine if the result is less than or equal to 10. Negative current data is compared to a constant2 to determine if the result is greater than or equal to negative five (−5). Once all determinations are combined, it is determined if the system is ready. If the system is ready, the output 143 is sent to 122 and ready lamp 130 is activated.

FIG. 7 shows parameters and determinations made with regards to the Soft Start Control determination 122 of FIG. 5. The soft start can and will limit an amount of power given from the battery, which will be a limited power until the state of the car reaches an optimum state where it can accept the full power. A determination 148 is made for secondary contactor 144 based on the ready output 143 and keyswitch 134 input. A determination 150 for main contactor 146 is made based on the battery fault, voltage fault, and voltage readings or input.

Module 102 also receives as input TrqLimit_In based on the output. TorqueLimitOut from Torque Limitation module 112. It may limit its communication from the batteries to their type and current state of charge. Based on the determined type and capacity, and, in some cases, the determined configuration, a TrqLimit is output from module 102 as input to Torque Limitation module 112. For example, the different chemistry and capacity of the batteries determines how much power can be requested from motor. Accordingly, the torque limitations can be adjusted.

FIG. 8 shows a more detailed view of the parameters analyzed and affected by Torque Limitation module 112. When TrqLimit input 152 is received from Inter process communication distribution module 102, determinations are made for an output torque limit percentage 154 and a torque limit output 156 (to be sent to engine as well as module 102). Such determinations may be made by one or separate modules. When input 152 is received, the average voltage of the entire battery pack, sensed current, and sensed state of charge (SOC) is compared to relative look up tables (LUT). Such LUTs may be saved in memory 16 or storage 17, for example. A comparison can be made to determine if the measurements fall within a predetermined range, and, based on those comparisons and addition of full torque (100 percent), a maximum current percentage of torque MaxCurrPerc is determined. Using the maximum current percentage of torque MaxCurrPerc, a torque limit percentage 154 is calculated. Additionally, the comparisons and maximum current percentage of torque MaxCurrPerc are used to adjust the torque limit output 156.

Battery Faults module 114 outputs data BattFaultOutput related to possible faults in battery performance. The data is input into module 102 as ErrChk_In so that module 102 can determine the current state of battery modules. For example, Battery Faults module 114 can determine if individual cells are low, temperature exceeds a predetermined amount, and/or if damage has occurred. Output ErrCond can be sent from Inter process communication distribution module 102 to Battery Faults module 114 based on any determinations made.

FIG. 9 shows a more detailed view of the parameters analyzed and affected by Battery Fault module 114. When FaultInput 158 is received from Inter process communication distribution module 102, determinations are made for occurrence of battery fault via indicator 160 and a battery fault output 162 (to be sent to module 102). Such determinations may be made by one or separate modules. Specifically, the battery pack voltage measurement (VoltLvl), sensed current (CurrentMeasOut), high cell value and low cell value (from BMS_Input 106) are used in calculations and compared to determine if a battery fault occurred. For example, pack voltage is compared to a constant to determine if the result is greater than or equal to a number of battery cells times the maximum cell voltage (of the pack). Pack voltage is compared to a constant4 to determine if the result is less than or equal to the number of battery cells times the minimum cell voltage (of the pack). Sensed current is compared to constant1 to determine if the result is greater than or equal to a maximum peak current. Sensed current is also compared to constant5 to determine if it is less than or equal to a maximum regenerative current. The high cell value is compared to constant2 to determine if the result is greater than or equal to a maximum cell voltage. The low cell value is compared to a constant3 to determine if it is less than a minimum cell voltage. Based on the combination of results, a determination is made regarding the occurrence of a battery fault, and an indicator 160 can be adjusted based on the battery fault output data 162.

Voltage Level module 116 outputs voltage data relating to individual and overall battery module/package voltage determinations. Voltage Level module 116 determines if there is a fault (e.g., exceeding voltage) in voltage measurement, and if a fault light should be lit. One or more faults may be indicated by Voltage Level module 116. Based on the BoltLvl_in and BMS_Input, for example, determinations can be made by Inter process communication distribution module 102 regarding the VoltLvl output. For example, a received input voltage reading VoltLvl_In by module 102 may determine that torque level output should be reduced. Accordingly, the voltage level reading received as input VoltgLvlCheck by Voltage Level module 116 can not only affect the battery modules but also affect the input to other subsystem modules.

FIG. 10 shows a more detailed view of the parameters analyzed and affected by Voltage Level module 116. When VltgLvlCheck input 164 is received from Inter process communication distribution module 102, determinations are made for a calibration 166 for a change in the allowable voltage, voltage fault indicator 168, and output voltage data 170 (to be sent to module 102). Such determinations may be made by one or separate modules. Specifically, the battery pack voltage measurement (VoltLvl), keyswitch voltage, and voltage at the capacitor are used, along with gain, to determine an average voltage 165. The battery pack voltage measurement (VoltLvl), keyswitch voltage, and voltage at the capacitor from VltgLvlCheck input 164 are also used to determine an allowable change or range (delta) in voltage level. Depending on the calibrated range or delta at 166, the calculations are used to determine if a voltage fault 167 has occurred and thus the type of light (if any) to be indicated by warning lamp or light (e.g., on dashboard) associated with voltage fault indicator 168. The data 167 for the voltage fault is combined with the average voltage determination 165 and used to calculate the voltage output data 170.

Current Measurement module 118 makes determinations regarding safety checks for the batteries in the vehicle. Current Measurement module 118 measures and determines if the current measurement of the battery modules is acceptable (or not). Using the current output from the battery packs, it can determine current consumed by motor and motor controller. Current Measurement module 118 can receive a current measurement or adjustment from module 102 as input Curr_Input 172. It outputs its determinations as CurrentMeasOut 174 which are received as input CurrMeas_In by Inter process communication distribution module 102. FIG. 11 shows a more detailed view of the parameters analyzed and affected by Current Measurement module 118. When Curr_Input 172 is received from Inter process communication distribution module 102, determinations are made for output current measurement 174 (to be sent to module 102) and state of charge indicator 176. Such determinations may be made by one or separate modules. The output current measurement data 174 uses the sensed current and a number of functions in its calculations. Current Measurement module 118 also determines a state of charge of battery packs. For example, current sensor amp hours, initial amp hours, state of charge, and pack voltage data can be used as input to determine the state of charge output 176. By integrating instantaneous current data collected over a period of time and then determining the amount of current input and output from the battery pack since startup of the vehicle. In an embodiment, the state of charge indicator 176 can be in the form of a gauge to indicate a number of hours (SessionAhrs).

Accordingly, the features of this disclosure describe a method (implemented via vehicle control firmware/software) that can detect multiple (e.g., five) different configurations of batteries for at least two different types of batteries; namely, lead-acid and lithium batteries. The solution allows for the vehicle to have battery packs that can be swapped without necessarily updating the electrical software associated with the systems in the vehicle. The method is capable of recognizing the type of batteries and the capacity of the batteries (and/or differentiating between at least lead acid and lithium batteries), and can adjust the state of charge and various other vehicle parameters based on those determinations. Thus, a customer can change and/or upgrade between one type of battery pack and another more easily. It also allows the OEM to offer a variety of battery pack configurations in the final product (e.g., vehicle 10) knowing that the customer/dealer can swap the packs without any major integration or rework.

This solution will work in any electric vehicle including where cost may be a concern and where there is a need to offer a number of different types of battery packs.

Any references to constants, LUTs, or calculations made herein can be adjusted as needed. Also, it should be understood that the features (e.g., constants and LUTs) used in the comparisons and described herein are battery-pack specific and can be adjusted according to the type, capacity, configuration, and manufacturer.

Accordingly, in an embodiment, this disclosure provides a method for adjusting vehicle parameters based on a type of battery modules inserted into a vehicle. The vehicle is configured to interchangeably accommodate at least two different types of batteries comprising a plurality of modules provided therein. Each module includes a plurality of batteries of a first type arranged into a first battery module that is interchangeable with a plurality of batteries of at least a second type arranged into a second battery module, the at least second type of batteries being different from the first type of batteries. Both of the first type and the at least second type of batteries are each separately configured to supply power to the vehicle. The vehicle includes a processor configured to communicate with a battery management system configured to monitor the modules and with one or more vehicle subsystems via a vehicle communication protocol. Each of the processor, the battery management system and the one or more vehicle subsystems have an input and output. The processor is configured to perform the method including: receiving at least one input parameter from the battery modules arranged in the vehicle of the vehicle via the vehicle communication protocol; determining at least a type and capacity of battery modules arranged in the vehicle based on the received one or more input parameters; adjusting output parameters to the battery management system and the one or more vehicle subsystems based on the at least determined type and capacity of battery modules, and outputting the adjusted output parameters to the battery management system and the one or more vehicle subsystems via the vehicle communication protocol. The method can further include: determining a configuration of the plurality of modules provided therein, and, wherein the adjusting the output parameters to the battery management system and the one or more vehicle subsystems is further based on the determined configuration. The processor can communicates via a CAN interface and wherein the vehicle communication protocol is a CAN bus protocol. Also, adjusting the output parameters using the method can include adjusting the state of charge of the battery modules. The determining of the at least a type of battery modules in the method can include determining if the battery modules are either a first type or a second type. The types of batteries configured for accommodation in the vehicle can be lithium batteries and lead acid batteries, and the determining of the at least a type of battery can include determining if lithium or lead acid batteries are arranged in the vehicle. The received at least one input parameter from the battery modules can be related to at least one selected from the group consisting of: soft start control determination, torque limitation, fault condition, voltage measurement, and current measurement. The adjusted output parameters to the battery management system can be related to at least one selected from the group consisting of: soft start control determination, torque limitation, fault condition, voltage measurement, and current measurement. The one or more vehicle subsystems can be at least one selected from the group consisting of: an engine management control unit, a safety system, an accident avoidance system, a braking system, and a steering control unit. Also, the output parameters for the one or more vehicle subsystems can be at least one selected from the group consisting of; state of charge (SOC), state of health (SOH), current, voltage, temperature, and capacity.

Other embodiments include incorporating the above methods into a set of computer executable instructions readable by a computer and stored on a data carrier or otherwise a computer readable medium, such that the method 24 is automated. In a possible embodiment, the methods may be incorporated into an operative set of processor executable instructions configured for execution by at least one processor or computer. FIG. 3 shows a flow chart of such computer readable instructions. For example, in some embodiments, memory or storage is configured such that when the executable instructions are executed by a computer or processor, they cause a computer or processor to automatically perform a method for adjusting vehicle parameters based on a type of battery modules inserted into a vehicle. Such instructions may be contained in memory 16 or storage 17, for example. Each of the above method steps of method 24 and functions associated with FIGS. 4-12 may be implemented by a processor or similar device through the design and installation of firmware in a vehicle, for example. The firmware may include a control program for each of the devices. It may or may not be updated once installed in a vehicle. In alternative embodiments, hard-wired circuitry may be used in place of or in combination with software instructions to implement the disclosure. Thus, embodiments of this disclosure are not limited to any specific combination of hardware circuitry and software. Any type of computer program product or medium may be used for providing instructions, storing data, message packets, or other machine readable information associated with the methods 100. As generally mentioned previously, computer readable medium, for example, may include non-volatile memory, such as a floppy, ROM, EPROM, flash memory, disk memory, CD-ROM, and other permanent storage devices (e.g., disk, drive) that are useful, for example, for transporting information, such as data and computer instructions. In any case, the medium or product should not be limiting.

It should be understood by one of ordinary skill in the art that signal conditioners, filter, converters, etc. may be implemented in this system, although they may not be described in detail herein.

While the principles of the disclosure have been made clear in the illustrative embodiments set forth above, it will be apparent to those skilled in the art that various modifications may be made to the structure, arrangement, proportion, elements, materials, and components used in the practice of the invention.

It will thus be seen that the features and advantages of this disclosure has been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A method for adjusting vehicle parameters based on a type of battery modules inserted into a vehicle, the vehicle comprising: the vehicle configured to interchangeably accommodate at least two different types of batteries comprising a plurality of modules provided therein, each module comprising a plurality of batteries of a first type arranged into a first battery module that is interchangeable with a plurality of batteries of at least a second type arranged into a second battery module, the at least second type of batteries being different from the first type of batteries, both the first type and the at least second type of batteries each separately configured to supply power to the vehicle, and a processor configured to communicate with a battery management system configured to monitor the modules and with one or more vehicle subsystems via a vehicle communication protocol, each of the processor, the battery management system and the one or more vehicle subsystems having an input and output; the processor configured to perform the method comprising:
receiving at least one input parameter from the battery modules arranged in the vehicle of the vehicle via the vehicle communication protocol;
determining at least a type and capacity of battery modules arranged in the vehicle based on the received one or more input parameters;
adjusting output parameters to the battery management system and the one or more vehicle subsystems based on the at least determined type and capacity of battery modules, and
outputting the adjusted output parameters to the battery management system and the one or more vehicle subsystems via the vehicle communication protocol.

2. The method according to claim 1, further comprising determining a configuration of the plurality of modules provided therein, and, wherein the adjusting the output parameters to the battery management system and the one or more vehicle subsystems is further based on the determined configuration.

3. The method according to claim 1, wherein the processor communicates via a CAN interface and wherein the vehicle communication protocol is a CAN bus protocol.

4. The method according to claim 1, wherein the adjusting the output parameters comprises adjusting the state of charge of the battery modules.

5. The method according to claim 1, wherein the determining of the at least a type of battery modules comprises determining if the battery modules are either a first type or a second type.

6. The method according to claim 1, wherein the types of batteries configured for accommodation in the vehicle are lithium batteries and lead acid batteries, and wherein the determining of the at least a type of battery comprises determining if lithium or lead acid batteries are arranged in the vehicle.

7. The method according to claim 1, wherein the received at least one input parameter from the battery modules is related to at least one selected from the group consisting of: soft start control determination, torque limitation, fault condition, voltage measurement, and current measurement.

8. The method according to claim 1, wherein the adjusted output parameters to the battery management system is related to at least one selected from the group consisting of: soft start control determination, torque limitation, fault condition, voltage measurement, and current measurement.

9. The method according to claim 1, wherein the one or more vehicle subsystems is at least one selected from the group consisting of: an engine management control unit, a safety system, an accident avoidance system, a braking system, and a steering control unit.

10. The method according to claim 1, wherein the output parameters for the one or more vehicle subsystems is at least one selected from the group consisting of: state of charge (SOC), state of health (SOH), current, voltage, temperature, and capacity.

11. An electric vehicle comprising:
a body configured to interchangeably accommodate at least two different types of batteries comprising a plurality of modules, each module comprising a plurality of batteries of a first type arranged into a first battery module that is interchangeable with a plurality of batteries of at least a second type arranged into a second battery module, the at least second type of batteries being different from the first type of batteries, and both the first type and the at least second type of batteries each separately configured to supply power to the vehicle;
a battery management system for monitoring the plurality of modules;
a plurality of vehicle subsystems;
a processor configured to communicate with the battery management system and with one or more of the plurality of vehicle subsystems via a vehicle communication protocol, each of the processor, the battery management system and the one or more vehicle subsystems having an input and output, and
wherein the processor is configured to: receive at least one input parameter from the battery modules arranged in the body of the vehicle via the vehicle communication protocol; determine at least a type and capacity of battery modules arranged in the vehicle based on the received one or more input parameters; adjust output parameters to the battery management system and the one or more vehicle subsystems based on the at least determined type and capacity of battery modules, and output the adjusted output parameters to the battery management system and the one or more vehicle subsystems via the vehicle communication protocol.

12. The vehicle according to claim 11, wherein the processor is further configured to determine a configuration of the plurality of modules provided therein, and, wherein the processor adjusts the output parameters to the battery management system and the one or more vehicle subsystems further based on the determined configuration.

13. The vehicle according to claim 11, wherein the processor communicates via a CAN interface and wherein the vehicle communication protocol is a CANbus protocol.

14. The vehicle according to claim 11, wherein the processor is configured to adjust the state of charge of the battery modules.

15. The vehicle according to claim 11, wherein the processor is configured to determine if the battery modules are either a first type or a second type.

16. The vehicle according to claim 11, wherein the types of batteries configured for accommodation in the vehicle are lithium batteries and lead acid batteries, and wherein the processor is configured to determine if lithium or lead acid batteries are arranged in the vehicle.

17. The vehicle according to claim 11, wherein the received at least one input parameter from the battery modules is at least one selected form the group consisting of: soft start control determination, torque limitation, fault condition, voltage measurement, and current measurement.

18. The vehicle according to claim 11, wherein the adjusted output parameters to the battery management system is at least one selected form the group consisting of: soft start control determination, torque limitation, fault condition, voltage measurement, and current measurement.

19. The vehicle according to claim 11, wherein the one or more vehicle subsystems is at least one selected from the group consisting of: an engine management control unit, a safety system, an accident avoidance system, a braking system, and a steering control unit.

20. The vehicle according to claim 1, wherein the output parameters for the one or more vehicle subsystems is at least one selected from the group consisting of: state of charge (SOC), state of health (SOH), current, voltage, temperature, and capacity.

21. A non-transitory computer readable medium having stored computer executable instructions, wherein the computer executable instructions, when executed by a computer, directs a computer to perform a method for adjusting vehicle parameters based on a type of battery modules inserted into a vehicle, the method comprising:
receiving at least one input parameter from the battery modules arranged in the vehicle of the vehicle via a vehicle communication protocol;
determining at least a type and capacity of battery modules arranged in the vehicle based on the received one or more input parameters;
adjusting output parameters to a battery management system configured to monitor the modules and one or more vehicle subsystems based on the at least determined type and capacity of battery modules, and
outputting the adjusted output parameters to the battery management system and the one or more vehicle subsystems via the vehicle communication protocol.

22. The medium according to claim 21, wherein the method further comprises determining a configuration of the plurality of modules provided therein, and, wherein the adjusting the output parameters to the battery management system and the one or more vehicle subsystems further comprises comprising based on the determined configuration.

23. The medium according to claim 21, wherein the adjusting the output parameters comprises adjusting the state of charge of the battery modules.

24. The medium according to claim 1, wherein the determining of the at least a type of battery comprises determining if lithium or lead acid batteries are arranged in the vehicle.
